(19) United States
(12) Patent Application Publication
(10) Pub. No.: US 2009/0095080 A1
(43) Pub. Date: Apr. 16, 2009

(54) CAPACITIVE DETECTOR

(75) Inventors: Hiroaki SASAKI, Tagajo (JP); Eiji Shikata, Sendai (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/207,513

(22) Filed: Sep. 10, 2008

(30) Foreign Application Priority Data
Oct. 15, 2007 (JP) 2007-268309

(51) Int. Cl. G01P 15/125

(52) U.S. Cl. 73/514.32

(57) ABSTRACT

A capacitive detector that accurately detects a physical quantity with a simple circuitry. An acceleration sensor includes a capacitance converter, an amplifier, a detection element unit, and a signal controller. The capacitor converter, which includes an operational amplifier, a switch, and a capacitor, converts a change in differential capacitance, which is obtained by fixed electrodes and a movable electrode, to voltage. The operational amplifier has a non-inversion input terminal, which receives a reference voltage. The signal controller supplies voltage that is applied to the fixed electrodes of the detection element unit. The signal controller includes a bias supply unit, which applies a predetermined bias voltage to the fixed electrodes during a test mode.

### BACKGROUND OF THE INVENTION

The present invention relates to a capacitive detector for detecting a physical quantity, such as acceleration, angular velocity, and pressure.

Capacitive detectors are used in acceleration sensors, angular velocity sensors, pressure sensors, and the like. Detectors having microscopic structures have been realized by implementing microelectromechanical systems (MEMS) technology. In such a capacitive detector, a movable electrode and fixed electrode are arranged facing toward each other to detect a physical quantity based on the capacitance between the movable and fixed electrodes. FIG. 4 shows the structure of a prior art acceleration sensor CS1. The acceleration sensor CS1 includes a detection element unit 10, a capacitance converter 20, a signal controller 30, and an amplifier 40.

The detection element unit includes fixed electrodes 11 and 12 and a movable electrode 13, which has a beam structure and faces toward the fixed electrodes 11 and 12. In such a structure, the movable electrode 13 moves in accordance with the applied physical quantity (e.g., acceleration). The fixed electrode 11 and movable electrode 13 and the fixed electrode 12 and movable electrode 13 form a differential capacitor, in which each capacitance is varied in accordance with the movement of the movable electrode 13.

The capacitance converter 20 converts changes in the differential capacitance obtained by the fixed electrodes 11 and 12 and the movable electrode 13 to voltage. The capacitance converter 20 includes an operational amplifier 21, a switch 22, and a capacitor 23. The operational amplifier 21 has an inversion input terminal connected to the movable electrode 13. The switch 22 and capacitor 23 are connected in parallel between the inversion input terminal and output terminal of the operational amplifier 21. A reference voltage V5 is applied to a non-inversion input terminal of the operational amplifier 21.

The amplifier 40 includes an amplification circuit, a lowpass filter, and a sample hold circuit. The amplification circuit amplifies the output voltage of the capacitance converter 20. The lowpass filter extracts only predetermined frequency bands from the output voltage of the amplification circuit. The sample hold circuit samples and holds the output voltage of the lowpass filter for a predetermined period and outputs an acceleration detection signal. An AD converter may be arranged in a subsequent stage of the sample hold circuit.

The signal controller 30 generates a rectangular wave, which includes a reset phase and an operation phase. The rectangular wave is applied to the fixed electrodes 11 and 12. Movement of the movable electrode 13 is measured from changes in the charge accumulated by the capacitance C1 of the fixed electrode 11 and movable electrode 13 and the capacitance C2 of the fixed electrode 12 and movable electrode 13.

The simplest way to check the functions of the acceleration sensor CS1 is to actually apply a physical quantity (e.g., acceleration) to the acceleration sensor CS1 and measure the output. However, when using a product, the application and measurement of acceleration is not practical from the aspects of cost and complicatedness. Therefore, to check an acceleration sensor, electrostatic force may be generated between the movable and fixed electrodes to produce a state in which a pseudo-physical quantity is applied to the acceleration sensor. In this state, the acceleration sensor undergoes self-diagnosis (self-testing). In the acceleration sensor CS1 shown in FIG. 4, test electrodes 15 are provided for the movable electrode 13. The application of voltage to the test electrodes 15 generates electrostatic force between the test electrodes 15 and the movable electrode 13 to conduct self-testing in a state in which a pseudo-physical quantity is generated.

A sensor that applies a test voltage to the fixed electrodes has also been proposed (refer to, for example, Japanese Laid-Open Patent Publication No. 5-322921 at page 1 and Japanese Laid-Open Patent Publication No. 2000-81449 at page 1). Japanese Laid-Open Patent Publication No. 5-322921 discloses a technique that improves the fail-safe feature of a sensor or system by conducting self-diagnosis of abnormalities, performance degradation, and wear in an acceleration sensor. In a diagnosis mode, a diagnosis power supply, which is arranged in a signal generator, generates a diagnosis signal. Then, an adder adds a detection voltage to the diagnosis signal and applies the resulting voltage to a fixed electrode of the sensor. This generates electrostatic force, which corresponds to the acceleration between the fixed and movable electrodes, such that a mass unit would move properly in a normal state.

In Japanese Laid-Open Patent Publication No. 2000-81449, a signal applied between fixed and movable electrodes includes cycles of a phase for detecting a capacitance change and a phase for moving a movable electrode. During the phase in which a capacitance change is detected, a C-V conversion circuit outputs voltage that is in accordance with a change in the differential capacitance obtained by fixed and movable electrodes to perform acceleration detection. During the phase in which the movable electrode is moved, when conducting self-diagnosis, the voltage applied to a non-inversion terminal of an operational amplifier in the C-V conversion circuit is switched from V/2 to V1 to apply pseudo-acceleration to the fixed electrode.

In the technique described in Japanese Laid-Open Patent Publication No. 5-322921, a large voltage is applied to one of the fixed electrodes to forcibly move the movable electrode. Thus, the voltage relationship of two movable electrodes differs between a normal mode and a self-test mode.

In the technique described in Japanese Laid-Open Patent Publication No. 2000-81449, different voltages are applied to the movable electrode. That is, the voltage applied to the movable electrode differs between the normal mode and self-test mode. Accordingly, the environment differs between the normal mode and self-test mode.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a preferred embodiment of an acceleration sensor according to the present invention;

FIG. 2A is a timing chart of a voltage applied to a first fixed electrode in a normal mode;

FIG. 2B is a timing chart of a voltage applied to a second fixed electrode in the normal mode;

FIG. 3 is a chart illustrating differential capacitance in the normal mode and in the test mode; and

FIG. 4 is a schematic diagram showing an acceleration sensor of the prior art.

### DETAILED DESCRIPTION OF THE PREFERRED EMBODIMENTS

The present invention provides a capacitive detector that accurately detects a physical quantity with a simple circuitry.

One aspect of the present invention is a capacitive detector for measuring a physical quantity. The capacitive detector includes a movable electrode which moves in accordance with a change in a physical quantity. A first fixed electrode and second fixed electrode are arranged facing toward the movable electrode. A signal controller applies voltages in a cycle including a first phase and a second phase. The signal controller applies a first voltage to the first fixed electrode and a second voltage to the second fixed electrode during the first phase and applies the second voltage to the first fixed electrode and the first voltage to the second fixed electrode during the second phase. A capacitance converter outputs voltage corresponding to a change in capacitance calculated from a measurement of an amount of change in charge accumulated in the movable electrode from the first phase to the second phase. A bias supply unit supplies a common direct current voltage to the first and second fixed electrodes. The bias moves the movable electrode.

In the capacitive detector, the second phase is shorter than an inverse of a resonant frequency of the movable electrode. Thus, movement of the movable electrode is ignorable when the physical quantity is being measured.

In the capacitive detector, the bias supply unit supplies a direct current voltage for correcting a predetermined physical quantity when measuring the physical quantity. This corrects errors of the movable electrode and fixed electrodes.

In the capacitive detector, the bias supply unit supplies a direct current voltage when receiving a test signal. This enables the functions of the capacitive detector to be temporarily checked.

In the capacitive detector, the physical quantity is acceleration. Thus, acceleration can be detected.

Other aspects and advantages of the present invention will become apparent from the following description, taken in conjunction with the accompanying drawings, illustrating by way of example the principles of the invention.

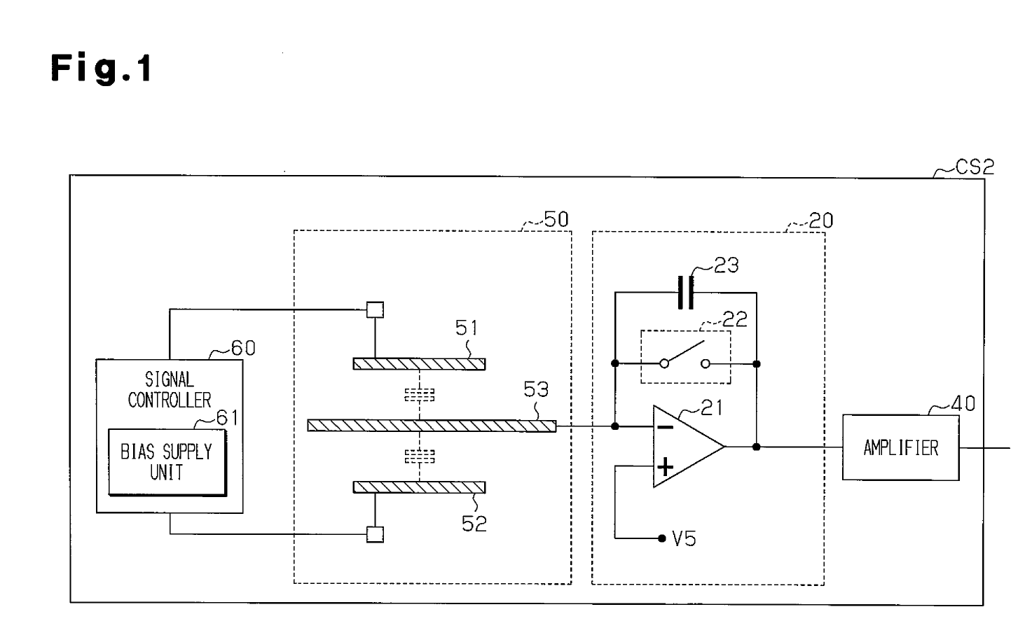

One embodiment of a capacitive detector in accordance with the present invention will now be discussed with reference to FIGS. 1 to 3. Referring to FIG. 1, the capacitive detector is embodied in an acceleration sensor CS2, which includes a capacitance converter 20, an amplifier 40, a detection element unit 50, and a signal controller 60.

The detection element unit 50 includes fixed electrodes 51 and 52 and a movable electrode 53, which is arranged between the electrodes 51 and 52 so as to face toward the electrodes 51 and 52. The fixed electrodes 51 and 52 are fixed to a substrate. The fixed electrode 51 and movable electrode 53 and the fixed electrode 52 and movable electrode 53 form a differential capacitor in which each capacitance varies in accordance with the movement of the movable electrode 53. The fixed electrode 51 serves as a first fixed electrode, and the fixed electrode 52 serves as a second fixed electrode.

The capacitance converter 20 converts changes in the differential capacitance obtained by the fixed electrodes 51 and 52 and movable electrode 53. In the preferred embodiment, a reference voltage V5 of [(V1+V2)/2] is input to a non-inversion terminal of the operational amplifier 21.

The amplifier 40, which includes a sample hold circuit, an amplification circuit, and a lowpass filter, amplifies the output voltage of the capacitance converter 20.

The signal controller 60 supplies the voltage applied to the fixed electrodes 51 and 52 of the detection element unit 50. Further, the signal controller 60 includes a bias supply unit 61. The bias supply unit 61 applies a predetermined bias voltage V3 to the fixed electrodes 51 and 52.

The fixed electrode 51 and movable electrode 53 obtain capacitance C1, and the fixed electrode 52 and movable electrode 53 obtain capacitance C2.

The operations performed in a normal mode will now be discussed.

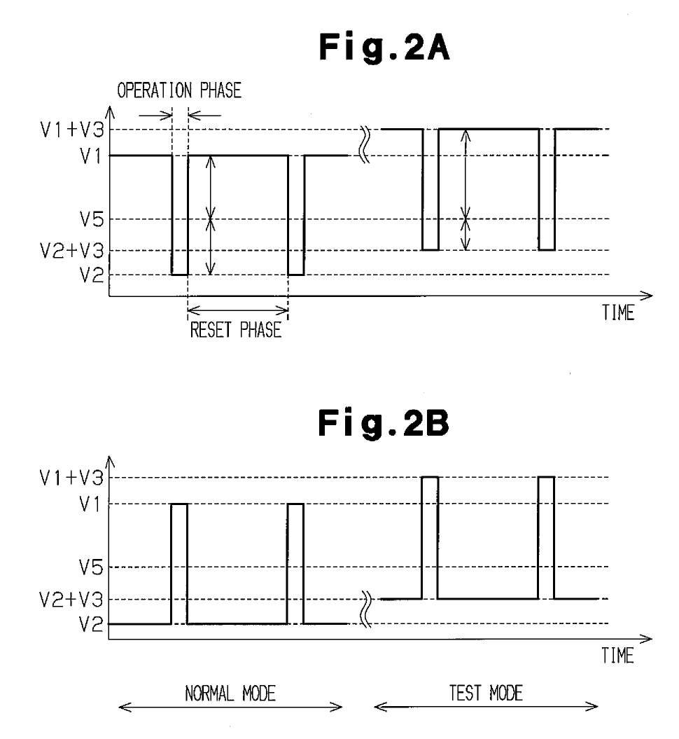

The switch 22 closes in a reset phase (first phase). This discharges the capacitor 23 and applies the reference voltage V5 (i.e., [(V1+V2)/2]) to the movable electrode 53. Then, referring to FIGS. 2A and 2B, the signal controller 60 supplies the fixed electrode 51 with a first voltage (voltage V1) and the fixed electrode 52 with a second voltage (voltage V2). In this case, the charge Q11 accumulated between the fixed electrode 51 and the movable electrode 53 and the charge Q12 accumulated between the fixed electrode 52 and the movable electrode 53 are expressed as shown below.

Q11=C1·(V1−V5)=C1·(V1−V2)/2

Q12=C2·(V2−V5)=C2·(V2−V1)/2

The switch 22 opens in an operation phase (second phase). Then, the signal controller 60 inverts the voltages V1 and V2 applied to the electrodes. In this case, the charge Q21 accumulated between the fixed electrode 51 and the movable electrode 53 and the charge Q22 accumulated between the fixed electrode 52 and the movable electrode 53 are expressed as shown below.

Q21=C1·(V2−V1)/2

Q22=C2·(V1−V2)/2

A difference ΔQ between a sum (Q11+Q12) of the charges accumulated between the movable electrode 53 and the fixed electrodes 51 and 52 during the reset phase and a sum (Q21+Q22) of the charges accumulated between the movable electrode 53 and the fixed electrodes 51 and 52 during the operation phase is expressed as shown below.

$$\begin{matrix}Δ Q = ( Q 11 + Q 12 ) - ( Q 21 + Q 22 ) \\ = ( C 1 - C 2 ) \cdot ( V 1 - V 2 ) \\ = Δ C \cdot ( V 1 - V 2 )\end{matrix}$$

Here, when the capacitance C1 is equal to the capacitance C2, the difference is expressed as ΔQ=0.

A difference between the capacitance C1 and the capacitance C2 produces a difference ΔQ. However, the operational amplifier 21 functions to hold the voltage at the movable electrode 53 to V5=(V1+V2)/2. Thus, the capacitance converter 20 outputs a voltage corresponding to the differential capacitance ΔC (C1−C2).

Accordingly, in the normal mode, the operations during the reset phase and operation phase are repeated in this manner. When the movable electrode 53 is moved by acceleration, a corresponding acceleration detection signal is output from the amplifier 40.

A test mode will now be described. In the test mode, a test mode signal is input to the signal controller 60. Then, the signal controller 60 adds a bias voltage to the voltage applied to the fixed electrodes 51 and 52. The bias voltage V3 is added to both of the fixed electrodes 51 and 52. Thus, the total amount of charge accumulated between the movable electrode 53 and the fixed electrodes 51 and 52 by the capacitances C1 and C2 of the fixed electrodes 51 and 52 does not change between the normal mode and the test mode. In a reset phase, the bias voltage V3 changes the potential distribution between the fixed electrode 51 and fixed electrode 52. That is, in a state in which the reference voltage V5 is maintained at the movable electrode 53, when the bias voltage V3 is applied to the two fixed electrodes 51 and 52, the electrostatic force applied to the movable electrode 53 loses balance. Then, while continuing to maintain the reference voltage V5, the movable electrode 53 moves to a position where the electrostatic force applied to the movable electrode 53 becomes balanced.

If the operation phase is short enough as compared with an inverse of the resonance frequency of the movable electrode 53, movement of the movable electrode 53 during the operation phase is ignorable. Movement of the movable electrode 53 varies the capacitances C1 and C2. As a result, the capacitance converter 20 supplies the amplifier 40 with the differential capacitance ΔC (C1−C2) as the output voltage.

The acceleration sensor of the preferred embodiment has the advantages described below.

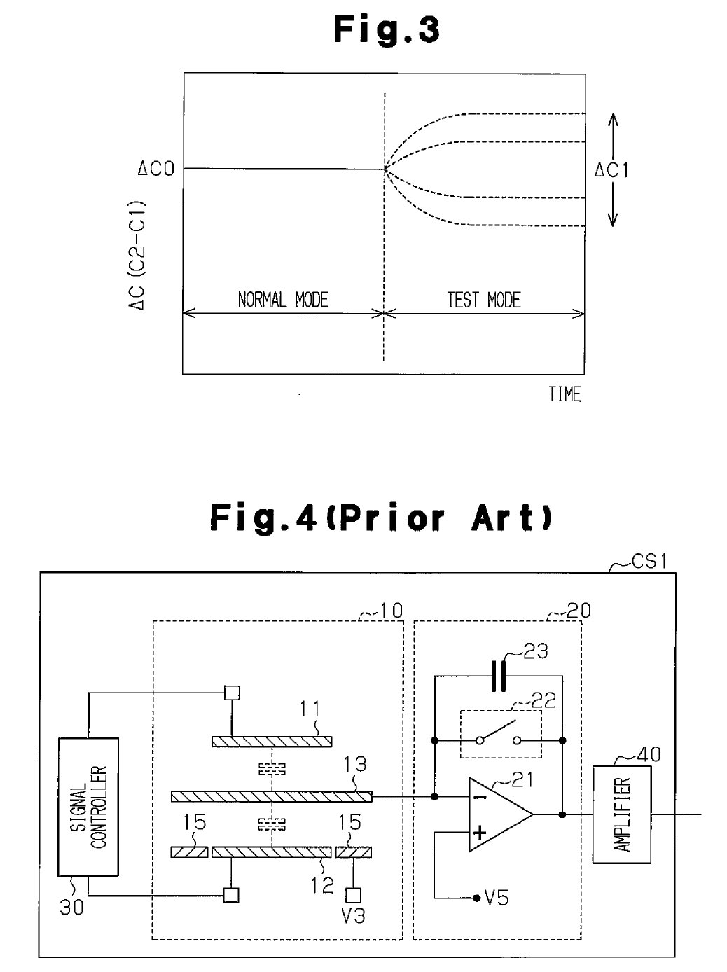

In the preferred embodiment, the bias voltage V3 is applied to the fixed electrodes 51 and 52. Thus, the functions of the acceleration sensor CS2 can be tested without a test electrode. As shown by the solid line in FIG. 3, in the normal mode, a differential capacitance ΔC0 that corresponds to the acceleration is measured. As shown by the broken lines in FIG. 3, in the test mode in which the bias voltage V3 is applied so that the movable electrode 53 moves toward the fixed electrode 51 or the fixed electrode 52, the bias voltage V3 is varied to change the differential capacitance ΔC1 so that the desired pseudo-acceleration is applied in any one of two directions.

The preferred embodiment differs from the technique described in Japanese Laid-Open Patent Publication No. 5-322921 in that a voltage step-up circuit is not necessary and in that the bias voltage V3 can be applied in the normal mode. Further, the amount of movement of the movable electrode can be large since the bias voltage V3 can be applied to both of the fixed electrodes 51 and 52.

It should be apparent to those skilled in the art that the present invention may be embodied in many other specific forms without departing from the spirit or scope of the invention. Particularly, it should be understood that the present invention may be embodied in the following forms.

In the preferred embodiment, an acceleration sensor is used as the capacitive detector. However, the present invention is not limited in such a manner. For example, the present invention may also be applied to a pressure sensor, a flow rate sensor, and an angular velocity sensor.

In the preferred embodiment, the bias voltage V3 is applied to test the acceleration sensor. However, the purpose for the application of the bias voltage V3 is not limited to the testing of the acceleration sensor. For example, the bias voltage V3 may be used if there are no changes in a direct current bias point for the CV characteristics in the capacitance converter 20 to correct an error in the acceleration sensor CS2. In this case, the output for the actual application of acceleration is measured. When there is an error, the bias voltage V3 is used to correct the error. Then, in the normal mode, the bias voltage V3 is constantly applied.

The present examples and embodiments are to be considered as illustrative and not restrictive, and the invention is not to be limited to the details given herein, but may be modified within the scope and equivalence of the appended claims.

1. A capacitive detector for measuring a physical quantity, the capacitive detector comprising:
a movable electrode that moves in accordance with a change in a physical quantity;
first and second fixed electrodes that face the movable electrode;
a signal controller that applies voltages in a cycle including a first phase and a second phase, with the signal controller applying a first voltage to the first fixed electrode and a second voltage to the second fixed electrode during the first phase and applying the second voltage to the first fixed electrode and the first voltage to the second fixed electrode during the second phase;
a capacitance converter that outputs voltage corresponding to a change in capacitance calculated from a measurement of an amount of change in charge accumulated in the movable electrode from the first phase to the second phase; and
a bias supply unit that supplies a common direct current voltage to the first and second fixed electrodes.

2. The capacitive detector according to claim 1, wherein the second phase is shorter than an inverse of a resonant frequency of the movable electrode.

3. The capacitive detector according to claim 1, wherein the bias supply unit supplies a direct current voltage for correcting a predetermined physical quantity when measuring the physical quantity.

4. The capacitive detector according to claim 1, wherein the bias supply unit supplies a direct current voltage when receiving a test signal.

5. The capacitive detector according to claim 1, wherein the physical quantity is acceleration.
